(19) United States
(12) Patent Application Publication
(10) Pub. No.: US 2026/0225259 A1
(43) Pub. Date: Aug. 6, 2026

(54) ROTARY WIRE HARNESS DISPENSING DEVICE

(71) Applicant: Ford Global Technologies, LLC, Dearborn, MI (US)

(72) Inventors: Jon Arthur Zimmerman, Ferndale, MI (US); Derrick Miller, Ypsilanti, MI (US); Kurt Michael Lundeen, Novi, MI (US)

(73) Assignee: Ford Global Technologies, LLC, Dearborn, MI (US)

(21) Appl. No.: 19/046,663

(22) Filed: Feb. 6, 2025

(51) Int. Cl. B25J 11/00; B25J 9/16; B25J 15/00; B60R 16/02

(52) U.S. Cl. CPC B25J 11/005; B25J 9/1679; B25J 15/0019; B60R 16/0207

(57) ABSTRACT

A system for installing a wiring harness into a vehicle that includes a spool, at least one robot, and a controller. The spool is configured to support the wiring harness and includes a first retaining feature configured to couple a first connector of the wiring harness to the spool. The robot is coupled to the spool and configured to move the spool. The controller is in communication with the robot and configured to instruct the robot to connect the first connector to a first module of the vehicle and instruct the robot to disconnect the first connector from the first retaining feature.

### FIELD

The present disclosure relates to a rotary wire harness dispensing device.

### BACKGROUND

The statements in this section merely provide background information related to the present disclosure and may not constitute prior art.

Industrial robots have been used for a variety of manufacturing operations, including by way of example, welding and moving parts from one location to another such as retrieving parts from a storage location and moving them to an assembly station. Automating the moving of some vehicle parts such as wire harnesses, for example, may be challenging because of the lack of proper handling of the part and mechanical repeatability.

These issues related to automating the handling of components, among other issues related to processing the components, are addressed by the present disclosure.

### SUMMARY

This section provides a general summary of the disclosure and is not a comprehensive disclosure of its full scope or all of its features.

In one form, the present disclosure provides a system for installing a wiring harness into a vehicle that includes a spool, at least one robot, and a controller. The spool is configured to support the wiring harness and includes a first retaining feature configured to couple a first connector of the wiring harness to the spool. The robot is coupled to the spool and configured to move the spool. The controller is in communication with the robot and configured to: instruct the robot to connect the first connector to a first module of the vehicle and instruct the robot to disconnect the first connector from the first retaining feature.

In variations of the system of the above paragraph, which can be implemented individually or in any combination: the robot connects the first connector to the first module and disconnects the first connector from the first retaining feature simultaneously; the spool includes body, a first flange and a second flange opposite the first flange, the first retaining feature is coupled to the first flange; the robot is coupled to a body of the spool; the spool includes a second retaining feature spaced apart from the first retaining feature, the second retaining feature is configured to couple a second connector of the wiring harness to the spool; each of the first and second retaining features includes a clip or hook-and-loop fastener; the controller is configured to: instruct the robot to connect the second connector to a second module of the vehicle after the first connector is connected to the first connector and instruct the robot to disconnect the second connector from the second retaining feature, the second module is spaced apart from the first module; the second retaining feature is coupled to the first flange; the second retaining feature is coupled to the second flange; and the robot connects the second connector to the second module and disconnects the second connector from the second retaining feature simultaneously.

In another form, the present disclosure provides a system for installing a wiring harness into a vehicle that includes a spool, at least one robot, and a controller. The spool is configured to support the wiring harness and includes a plurality of retaining features. A first retaining feature of the plurality of retaining features is configured to couple a first connector of the wiring harness to the spool and a second retaining feature of the plurality of retaining features is configured to couple a second connector of the wiring harness to the spool. The robot is coupled to the spool and configured to move the spool. The controller is in communication with the robot and configured to: instruct the robot to connect the first connector to a first module located at a first location of the vehicle, instruct the robot to disconnect the first connector from the first retaining feature, instruct the robot to move the spool to a second location of the vehicle to connect the second connector to a second module of the vehicle after the first connector is connected to the first module, and instruct the robot to disconnect the second connector from the second retaining feature, the wiring harness is at least partially unwound on the spool in response to the robot moving the spool from the first location toward the second location.

In variations of the system of the above paragraph, which can be implemented individually or in any combination: the robot connects the first connector to the first module and disconnects the first connector from the first retaining feature simultaneously, the robot connects the second connector to the second module and disconnects the second connector from the second retaining feature simultaneously; each of the plurality of retaining features includes a clip or hook-and-loop fastener; the spool includes a first flange and a second flange opposite the first flange, the first and second retaining features are coupled to a periphery of the first flange; the plurality of retaining features includes a third retaining feature configured to couple a third connector of the wiring harness to the spool, and wherein the controller is configured to: instruct the robot to move from the second location to a third location of the vehicle to connect the third connector to a third module of the vehicle after the second connector is connected to the second module, and instruct the robot to disconnect the third connector from the third retaining feature, the wiring harness is further unwound on the spool in response to the robot moving the spool from the second location toward the third location; the third retaining feature is coupled to the periphery of the first flange; the third retaining feature is coupled to a periphery of the second flange; and the robot includes a first robot configured to move the spool from the first location to the second location and a second robot configured to disconnect the first connector from the first retaining feature and connect the first connector to the first module of the vehicle and disconnect the second connector from the second retaining feature and connect the second connector to the second module of the vehicle.

In yet another form, the present disclosure provides a system for installing a wiring harness into a vehicle that includes a spool, the wiring harness, at least one robot, and a controller. The spool includes a first flange, a second flange opposite the first flange, and a plurality of retaining features coupled to at least one of the first flange and second flange. The wiring harness is wound around the spool and includes a plurality of connectors. Each retaining feature of the plurality of retaining features is configured to couple a respective connector of the plurality of connectors to the spool. The robot is coupled to the spool and is configured to move the spool. The controller is in communication with the robot and configured to: instruct the robot to connect a first connector of the plurality of connectors to a first module located at a first location of the vehicle, instruct the robot to disconnect the first connector from a first retaining feature of the plurality of retaining features, instruct the robot to move the spool to a second location of the vehicle to connect a second connector of the plurality of connectors to a second module of the vehicle after the first connector is connected to the first module, and instruct the robot to disconnect the second connector from the second retaining feature of the plurality of retaining features. The wiring harness is at least partially unwound on the spool in response to the robot moving the spool from the first location toward the second location.

In variations of the system of the above paragraph, the robot includes a first robot and a second robot. The first robot is configured to move the spool from the first location to the second location. The second robot is configured to disconnect the first connector from the first retaining feature and connect the first connector to the first module of the vehicle and disconnect the second connector from the second retaining feature and connect the second connector to the second module of the vehicle.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a system for handling a wire harness component of a vehicle according to the principles of the present disclosure with the wire harness component wound around a spool of the system;

FIG. 2A is a perspective view of a robot of the system of FIG. 1 coupled to the spool of the system of FIG. 1;

FIG. 2B is a perspective view of the spool;

FIG. 3A is a side view of the spool of FIG. 1 with the wire harness component removed for clarity;

FIG. 3B is an end view of the spool of FIG. 1 with the wire harness component removed for clarity;

FIGS. 3C and 3D are perspective views of alternate retaining features that can be incorporated into the spool of FIG. 1;

FIGS. 4A-4C are schematic views showing the robot connecting the electrical connectors into modules of a vehicle;

FIG. 5 is a schematic block diagram showing components of the system of FIG. 1 in accordance with the teachings of the present disclosure; and

FIG. 6 is a flowchart depicting an algorithm for handling the wire harness component of the system of FIG. 1 in accordance with the teachings of the present disclosure;

FIG. 7A is a perspective view of another system for handling a wire harness component of a vehicle according to the principles of the present disclosure;

FIG. 7B is a perspective view of a portion of a robot of the system of FIG. 7A;

FIG. 8 is a schematic block diagram showing components of the system of FIG. 7A in accordance with the teachings of the present disclosure; and

FIG. 9 is a flowchart depicting an algorithm for handling the wire harness component of the system of FIG. 7A in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

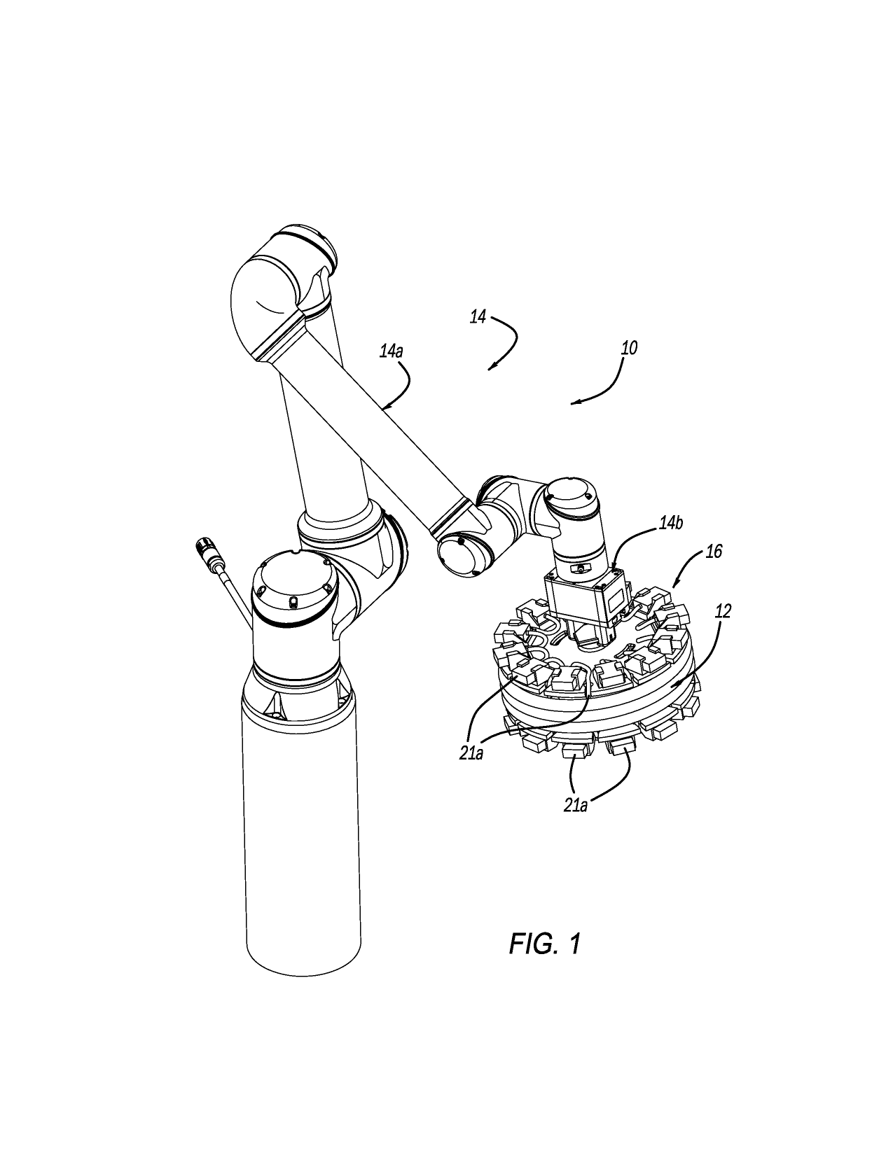

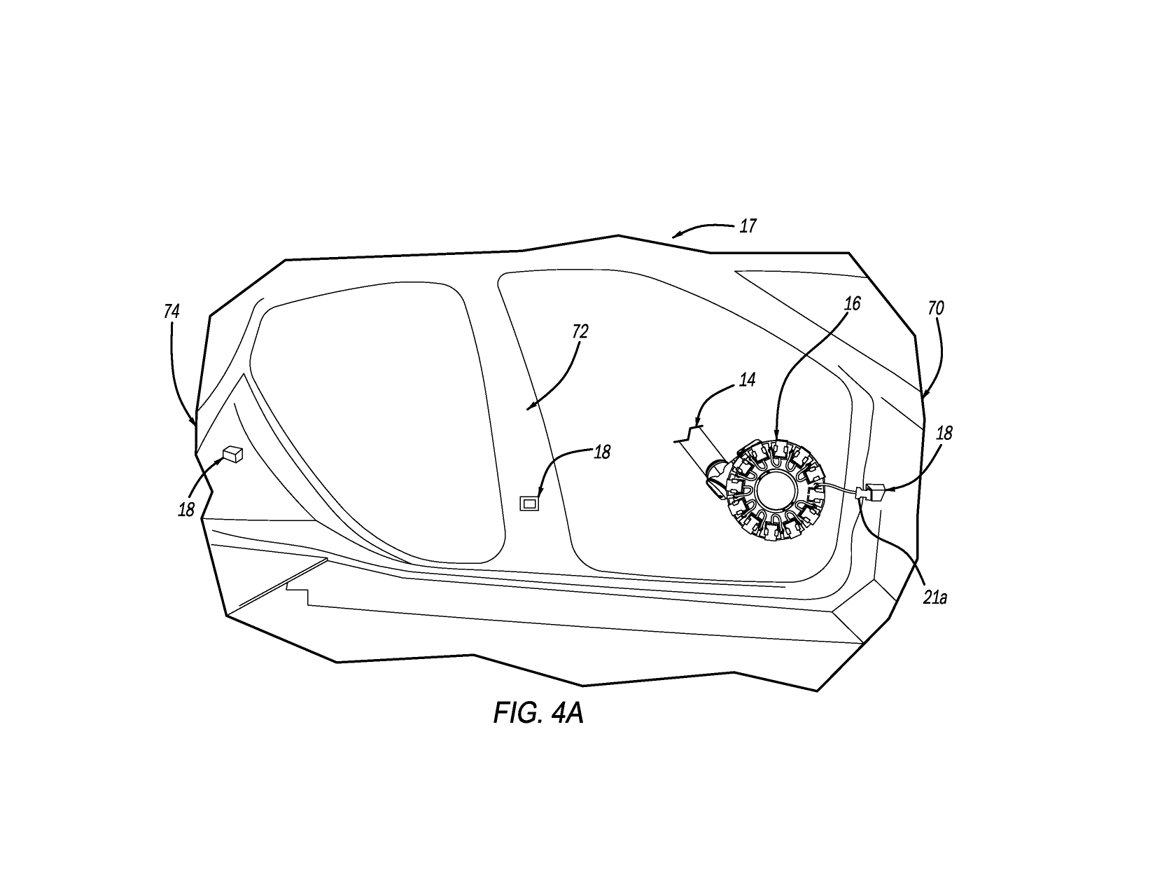

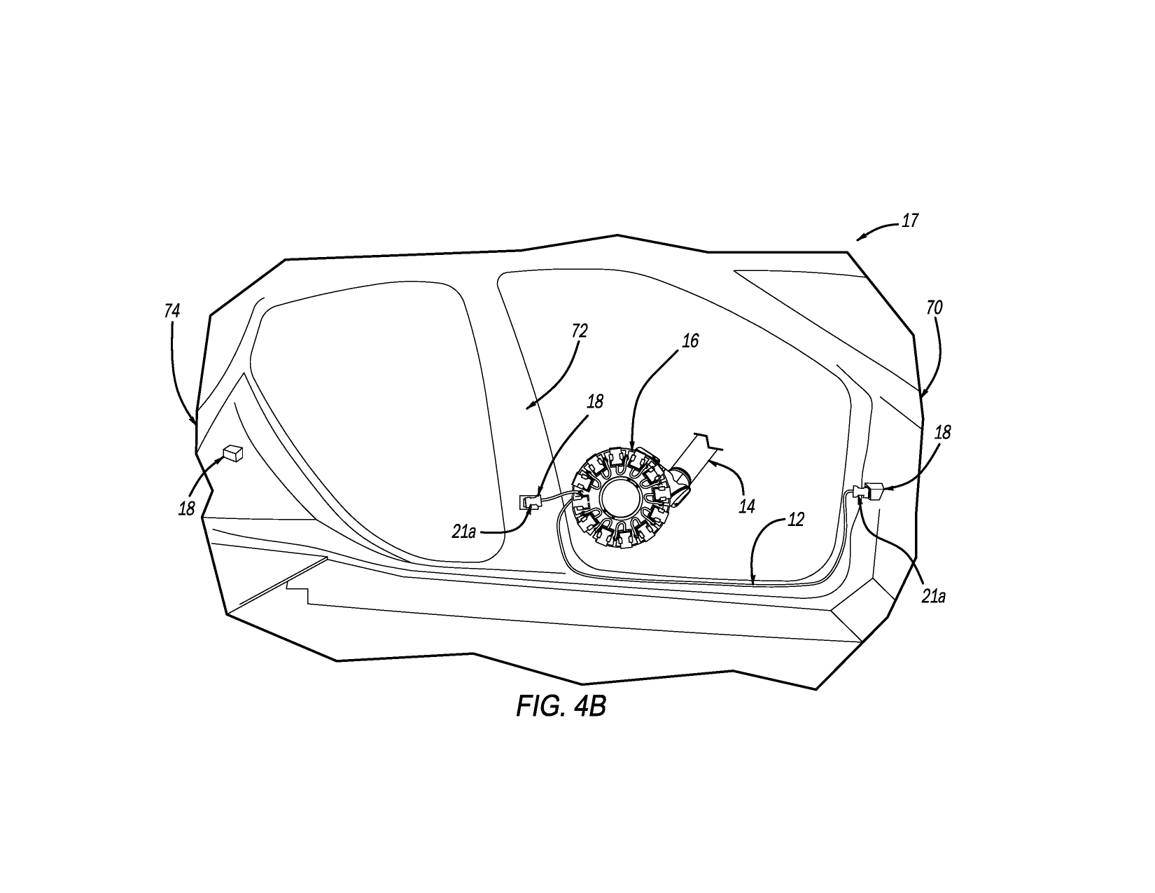

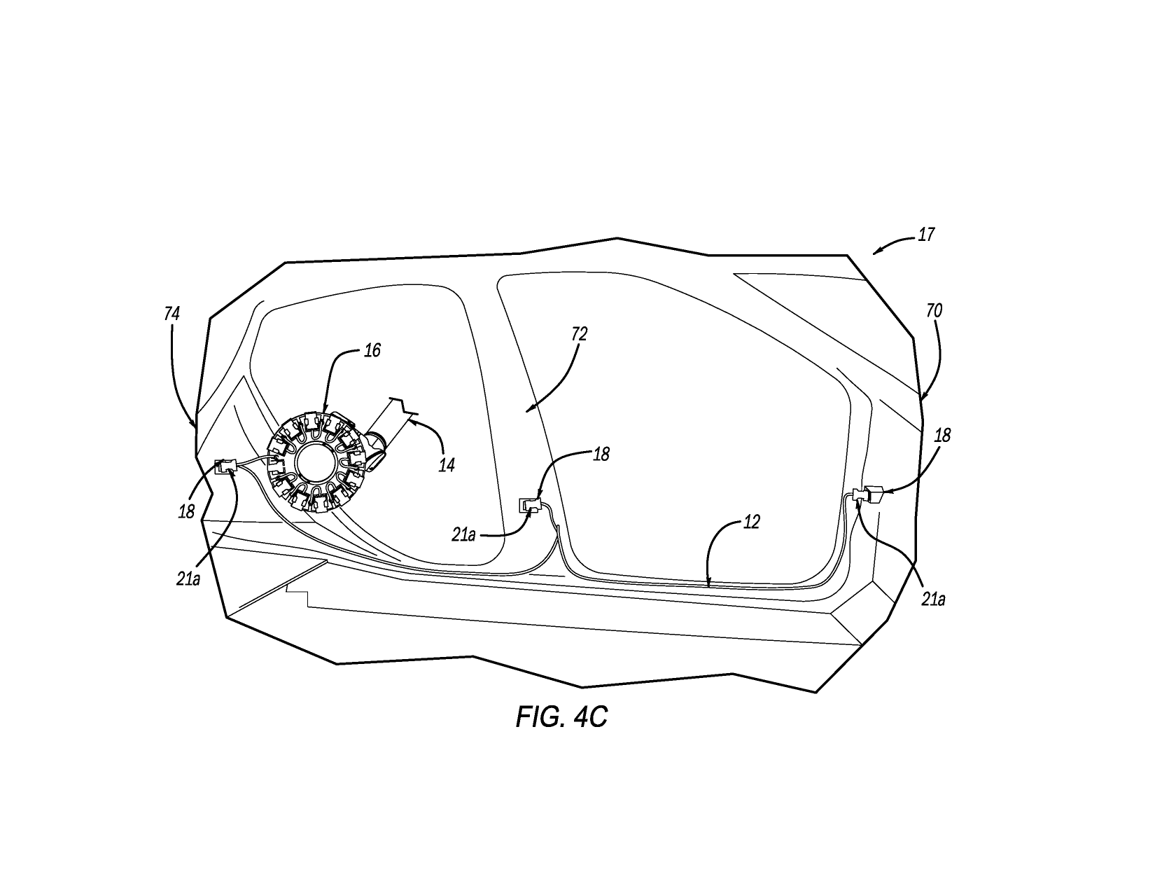

With reference to FIG. 1, a system 10 for handling one or more vehicle components 12 is illustrated. The handling of the vehicle components 12 may include retrieving the vehicle components 12 from a part support (e.g., a dunnage rack), placing the vehicle components 12 onto a work surface, manipulating parts of the vehicle components 12 on the work surface, and/or installing the vehicle components 12 into a vehicle 17 (FIGS. 4A-4C). The system 10 allows for the handling of the vehicle components 12 with little to no human intervention. In this way, the handling of the vehicle components 12 may be automated to increase productivity, reduce cycle time, and reduce variation and error, for example. In the example illustrated, the vehicle components 12 may include wire harnesses or wiring harnesses. That is, wire harnesses tend to include flexible, complex, and highly variable from one part to the next, so that installation of the wire harness into the vehicle 17 may be challenging to automate. The system 10 of the present disclosure provides for the adaptation of vehicle components 12 such as wire harnesses to better support automation. It should be understood that the vehicle components 12 may be other components of a vehicle other than wire harnesses.

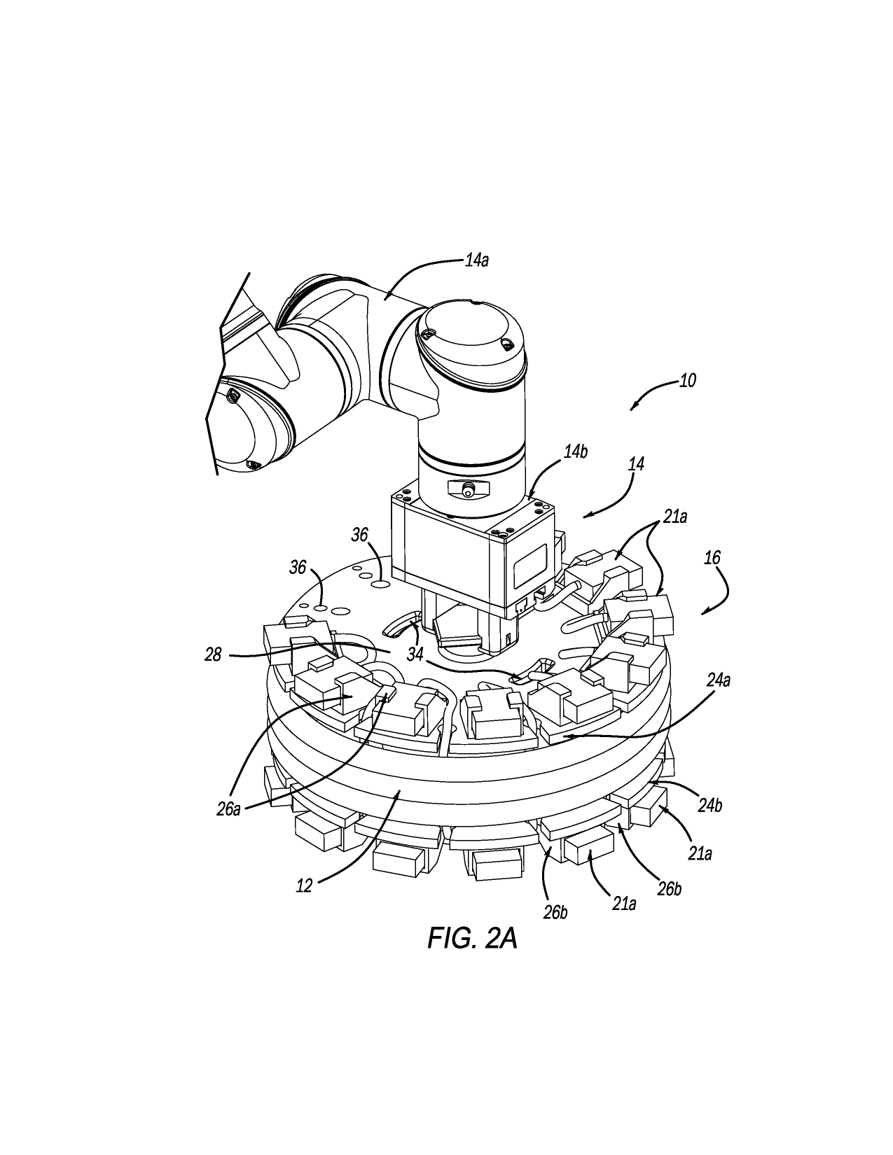

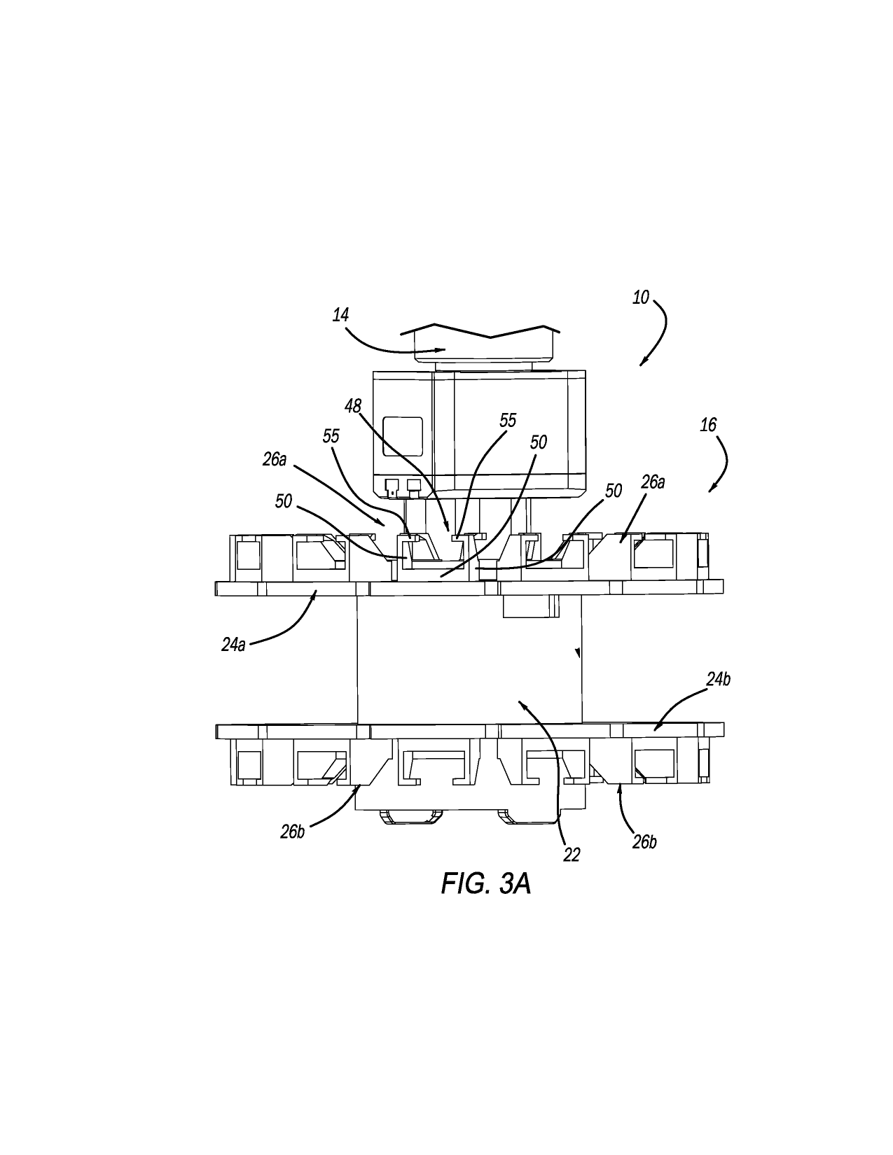

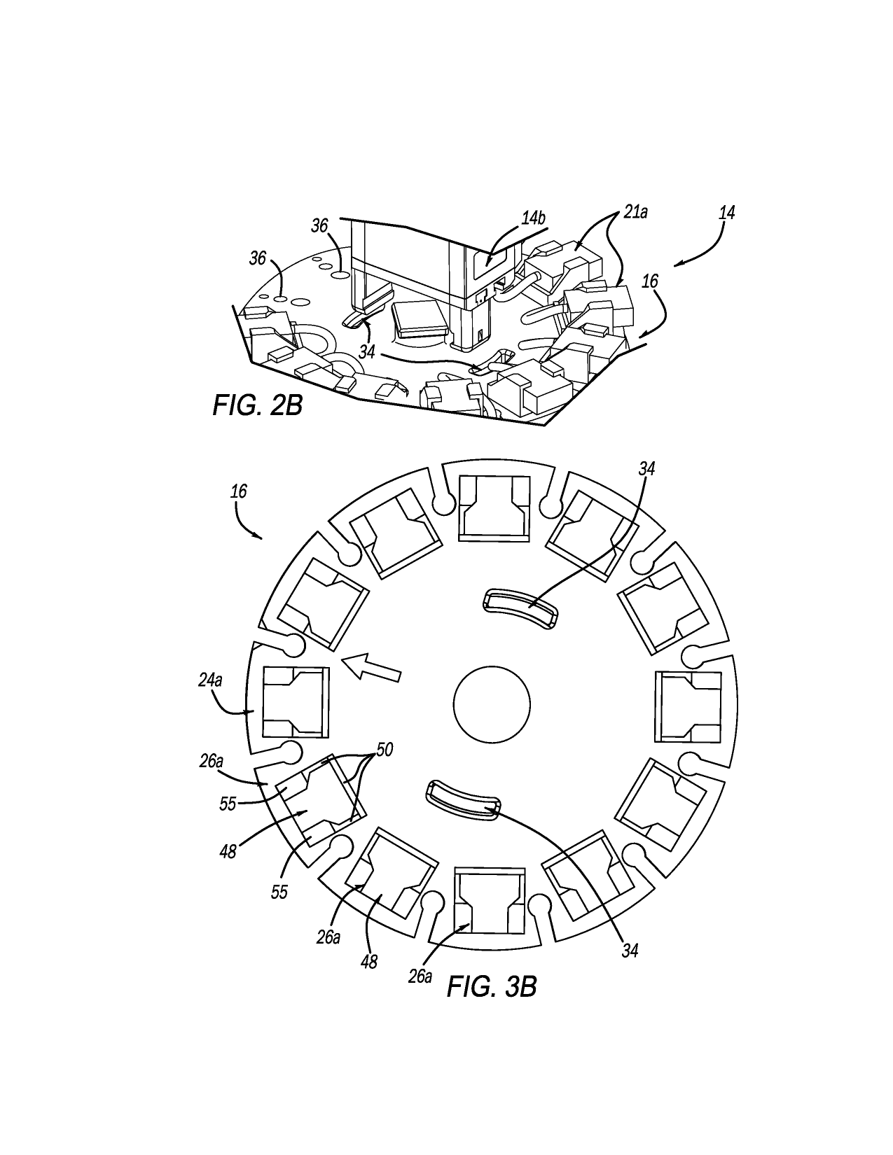

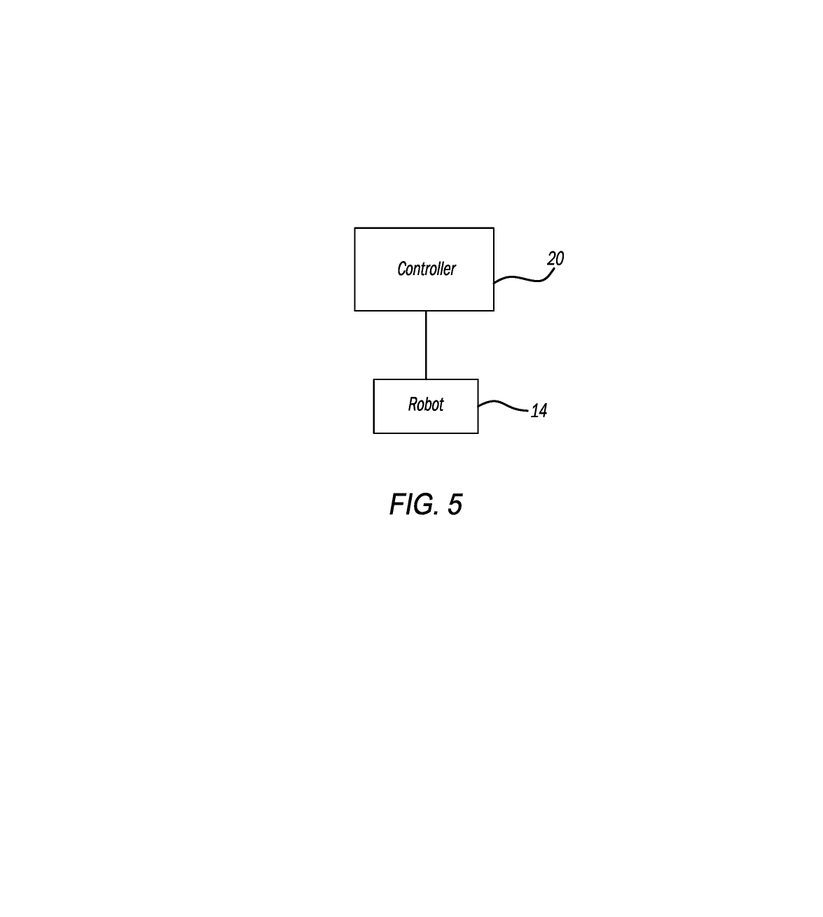

With reference to FIGS. 1, 2, 3A-3B, the system 10 includes at least one robot 14, a spool 16, the vehicle component 12 (FIGS. 1 and 2), and a controller 20 (FIG. 5). The robot 14 is configured to move the spool 16 and the vehicle component 12 from the work surface (not shown), for example, to the vehicle 17, couple electrical connectors 21a of the vehicle component 12 to vehicle modules 18 of the vehicle 17, and decouple or detach the electrical connectors 21a of the vehicle component 12 from the spool 16. The robot 14 includes a robot arm 14a and a robotic gripper structure or apparatus 14b. The robot arm 14a includes a plurality of segments connected to each other at joints, thereby allowing the robot 14 to have multiple degrees of freedom. In one form, the robot arm 14a is secured to the work surface at a first end. In some variations, the robot arm 14a includes an optional adapter (not shown) that is adapted to be secured to the work surface. In some forms, the robot 14 is separate from the work surface and is partially or fully autonomous and is configured to autonomously move to the part support (not shown) and/or work surface as instructed by the controller 20. To autonomously move itself, the controller 20 is configured to control various movement systems of the robot 14 based on location data obtained from one or more sensors. In an example application, the movement systems may include propulsion systems, steering systems for controlling wheels, and/or other systems, and the sensors for providing location data may include a GNSS sensor, an imaging sensor, a local position sensor, among others.

The robotic gripper structure 14b is secured to the robot arm 14a and is configured to be removably coupled to the spool 16. In this way, the robotic gripper structure 14b may grip the spool 16 and move the spool 16 from one location to another location as will be described in more detail below. In the example illustrated, the robot gripper structure 14b is coupled to the spool 16. In some forms, the robot gripper structure 14b may be coupled to a periphery of the spool 16 or to any other suitable location of the spool 16 such that the robot 14 may move the spool 16. The robotic gripper structure 14b may also manipulate the spool 16 (e.g., rotate the spool 16) to connect the electrical connectors 21a of the vehicle component 12 to terminals of the vehicle modules 18 as will be described in more detail below. In one example, the vehicle modules 18 may be an engine control module that controls multiple systems of an internal combustion engine. In another example, the vehicle modules 18 may be a suspension module that controls the suspension and adjust the tension for each wheel independently. It should be understood that the modules may be other modules configured to control operation of the vehicle 17 and its systems.

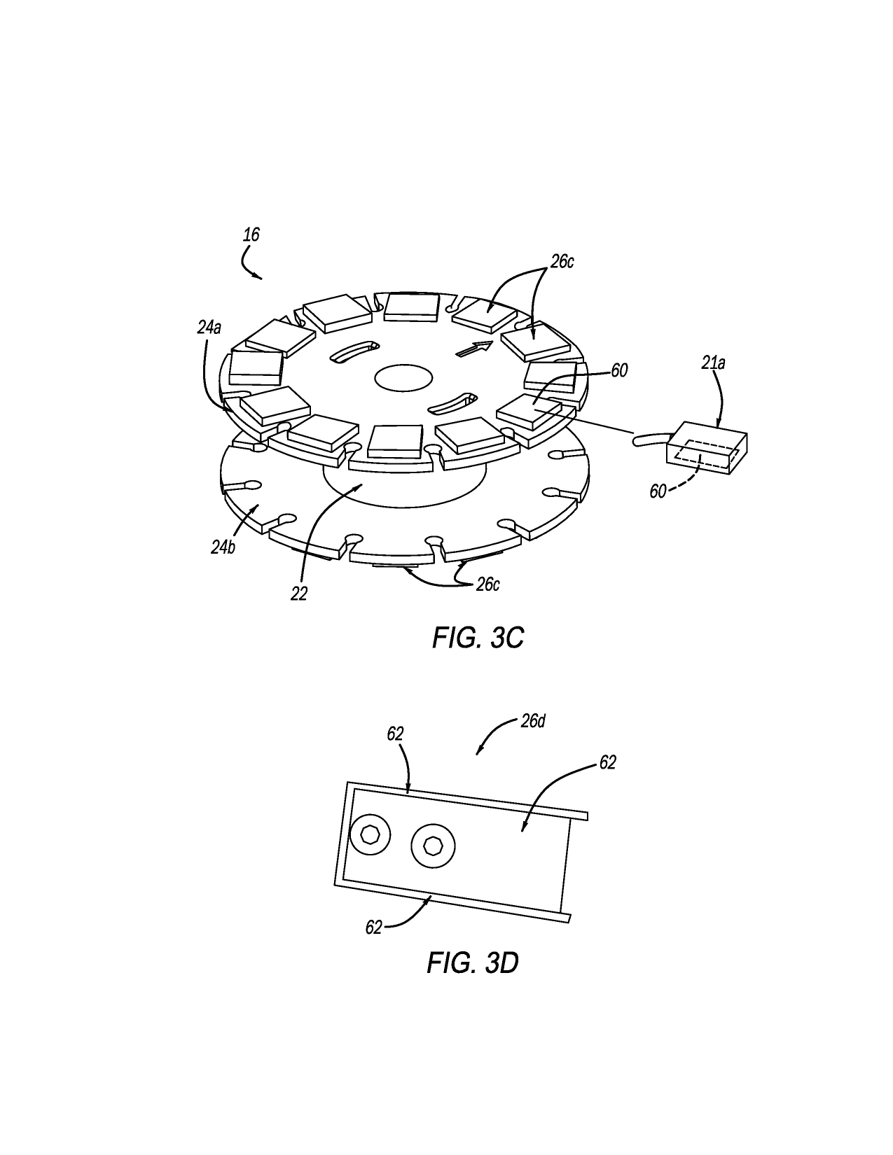

The spool 16 is configured to support the wiring harness 12 and includes the body 22 (FIG. 3A), flanges 24a, 24b, and a plurality of retaining features 26a, 26b. The body 22 and the flanges 24a, 24b cooperate to form a space where the wiring harness 12 is wound. In the example illustrated, the body 22 has a cylindrical shape. In some forms, the body 22 may have a different shape such as elliptical. In one form, the body 22 is hollow. In another form, the body 22 is solid. In the example illustrated, the body 22 has axial ends 28 (only one shown in the figures) that includes a plurality of mounting features 34. The mounting features 34 may be a combination of slots, apertures and/or grooves. In one form, the mounting features 34 facilitate coupling of the robot 14 to the spool 16. That is, the robotic gripper structure 14b may be coupled to the body 22 via the mounting features 34 to removably couple the robot 14 to the spool 16. In another form, the mounting features 34 reduces the weight of the spool 16. In yet another form, the mounting features 34 facilitates coupling of the retaining features 26a, 26b to the spool 16. In this form, the mounting features 34 may be arranged in a desired pattern to facilitate attaching the retaining features 26a, 26b to the body 22.

Each flange 24a, 24b extends radially outward from a respective axial end 28 of the body 22 and may be configured to inhibit movement of the wiring harness 12 in the axial direction (i.e., along a length of the body 22 of the spool 16). The flange 24a, 24b may include a plurality of mounting features 36 (FIGS. 2A and 2B). The mounting features 36 may be a combination of slots, apertures and/or grooves. In one form, the mounting features 36 reduces the weight of the spool 16. In another form, the mounting features 36 facilitates coupling of the retaining features 26a, 26b to the spool 16 as will be described in more detail below. In this form, the mounting features 36 may be arranged in a desired pattern to facilitate attaching the retaining features 26a, 26b to the spool 16 and detaching the electrical connectors 21a from the spool 16. In yet another form, the mounting features 36 may facilitate coupling of electrical components 21 (e.g., wires) of the wiring harness 12 to the spool 16. In this way, the wiring harness 12 is further supported on the spool 16 as the spool 16 is being moved from one location to another location. In some forms, the mounting features 36 may facilitate coupling of the robot 14 to the spool 16. That is, the robotic gripper structure 14b may be coupled to the flange 24a, 24b via the mounting features 36 to removably couple the robot 14 to the spool 16.

With reference to FIGS. 2, 3A, and 3B, the retaining features 26a, 26b are coupled to the flanges 24a, 24b, respectively, of the spool 16 and are configured to support electrical connectors 21a of the wiring harness 12 on the spool 16. In some forms, the retaining features 26a, 26b may be coupled to the flange 24a instead of the flange 24b. Still, in other forms, the retaining features 26a, 26b may be coupled to the axial end 28 of the body 22 to support electrical connectors 21a of the wiring harness 12 on the body 22 of the spool 16.

The retaining features 26a, 26b are removably coupled to the flanges 24a, 24b, respectively, and are spaced apart from each other along the flanges 24a, 24b. In the example illustrated, the retaining features 26a, 26b are coupled to the flange 24a, 24b, respectively, via mechanical fasteners such as bolts, screws or rivets, for example, extending through mounting features 36 of the flanges 24a, 24b. In this way, the pattern at which the retaining features 26a, 26b are arranged along the spool 16 can be changed, modified, or updated as desired. In some forms, the retaining features 26a, 26b may be coupled to the flanges 24a, 24b using a snap button system, hook-and-loop fasteners (VELCRO), or any other suitable attachment mechanism where the pattern at which the retaining features 26a, 26b are arranged along the spool can be updated as desired.

The retaining features 26a, 26b are configured to removably couple the electrical connectors 21a to the spool 16 using a variety of attachment methods. In the example shown in FIGS. 3A and 3B, each retaining feature 26a, 26b is coupled to a respective flange 24a, 24b and includes a space 48 formed by walls 50 of the retaining feature 26a, 26b that receives a respective electrical connector 21a. In this way, the respective electrical connector 21a is clipped to the retaining feature 26a, 26b while the robot 14 moves the spool 16. Two walls 50 may include flanges 55 extending over the electrical connector 21a to further retain the electrical connector 21a to the retaining features 26a, 26b. In another example, as shown in FIG. 3C, a retaining feature 26c may be coupled to a respective flange 24a, 24b and includes a hook-and-loop fasteners system 60 that connects to the respective electrical connector 21a. That is, one of the retaining feature 26c and the respective electrical connector 21a includes hooks that cooperate with loops of the other of the retaining feature 26a and the respective electrical connector 21a, thereby coupling the respective electrical connector 21a of the wiring harness 12 to the spool 16. In yet another example shown in FIG. 3D, the retaining feature 26d includes a space formed by resiliently flexible walls 62 of the retaining feature 26d that receives a respective electrical connector 21a. In this way, the respective electrical connector 21a is retained to the retaining feature 26d by friction fit, for example, while the robot 14 moves the spool 16. It should be understood that the spool 16 may include a combination of retaining features 26a, 26b, 26c, 26d disclosed above without departing from the scope of the present disclosure.

The wiring harness 12 is wound around the body 22 of the spool 16 such that the spool 16 supports the wiring harness 12. As described above, the electrical connectors 21a of the wiring harness 12 are coupled to the retaining features 26a, 26b as the robot 14 moves the spool 16. As will be described in more detail below, the wiring harness 12 is unwound from the spool 16 as the robot 14 connects the electrical connectors 21a to the vehicle modules 18.

With reference to FIG. 5, the controller 20 is in communication with the robot 14 and may monitor and control operations of the robot 14 based on data received. In one example, the controller 20 is in communication with the robot 14 using a wired or wireless communication protocol (e.g., a Bluetooth®-type protocol, a cellular protocol, a wireless fidelity (Wi-Fi)-type protocol, a near-field communication (NFC) protocol, an ultra-wideband (UWB) protocol, among others).

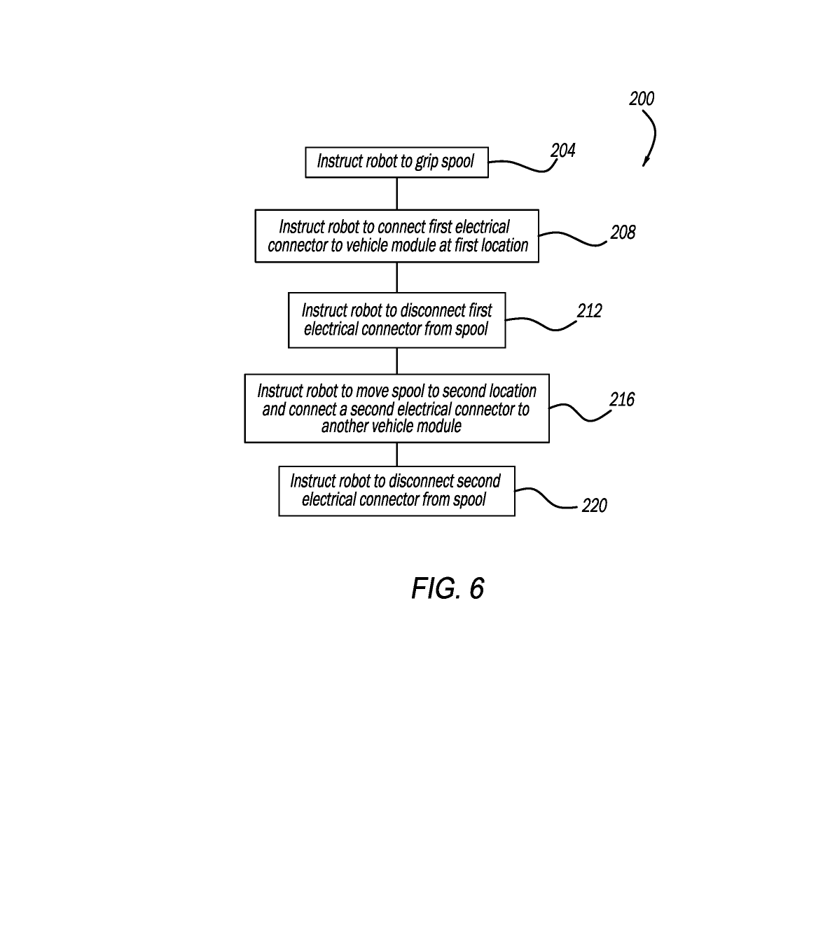

Referring to FIG. 6, an example control algorithm 200 for installing the wiring harness 12 into the vehicle 17 is illustrated. The processing may begin once the wiring harness 12 is moved from the part support (not shown) to the work surface or the area where the robot 14 is located. At 204, the control algorithm, using the controller 20, instructs the robot 14 to grip the spool 16 having the wiring harness 12 wound thereon. At 208, the control algorithm, using the controller 20, instructs the robot 14 to connect a first electrical connector 21a of the spool 16 to a respective vehicle module 18 of the vehicle 17 (FIG. 4A). In the example illustrated, the respective module 18 is located at a front 70 of the vehicle 17. In another form, the respective module 18 may be located at a rear 74 of the vehicle 17. In yet another form, the respective module 18 may be located at a middle portion 72 of the vehicle 18 or any other location of the vehicle 17 including vehicle modules. It should be understood that the robot 14 may manipulate the spool 16 (e.g., rotate the spool 16) such that the first electrical connector 21a is connected to the respective module 18.

At 212, the control algorithm, using the controller 20, instructs the robot 14 to disconnect or detach the first electrical connector 21a from the spool 16 (i.e., detach the first electrical connector 21a from the respective retaining feature 26a, 26b of the spool 16). For example, after the first electrical connector 21a has been connected to the respective module 18, the robot 14 may move the spool 16 away from the respective module 18, thereby disconnecting the first electrical connector 21a from the retaining feature 26a, 26b of the spool 16. Stated differently, the connection between the first electrical connector 21a and the retaining feature 26a, 26b may be overcome once a predetermined force is applied to the spool 16, thereby disconnecting the first electrical connector 21a from the retaining feature 26a, 26b. In some forms, movement by the robot 14 to connect the first electrical connector 21a to the respective module 18 and disconnect the first electrical connector 21a from the retaining feature 26a, 26b may occur simultaneously.

At 216, the control algorithm, using the controller 20, instructs the robot 14 to move the spool 16 to a second location of the vehicle 17 and connect the second electrical connector 21a to another vehicle module 18. In the example illustrated, the second location of the vehicle 17 may be a middle portion of the vehicle 17 (FIG. 4B). In some forms, the second location of the vehicle 17 may be a rear of the vehicle 17 or another location of the vehicle 17 that is spaced apart from the front of the vehicle 17. It should be understood that the wiring harness 12 may be at least partially unwound on the spool 16 in response to the robot 14 moving from the first location toward the second location.

At 220, the control algorithm, using the controller 20, instructs the robot 14 to disconnect or detach the second electrical connector 21a from the spool 16 (i.e., detach the second electrical connector 21a from the respective retaining feature 26a, 26b of the spool 16). For example, after the second electrical connector 21a has been connected to the respective module 18, the robot 14 may move the spool 16 away from the respective module 18, thereby disconnecting the second electrical connector 21a from the retaining feature 26 of the spool 16. Stated differently, the connection between the second electrical connector 21a and the retaining feature 26a, 26b may be overcome once a predetermined force is applied to the spool 16, thereby disconnecting the second electrical connector 21a from the retaining feature 26a, 26b.In some forms, movement by the robot 14 to connect the second electrical connector 21a to the respective module 18 and disconnect the second electrical connector 21a from the retaining feature 26a, 26b may occur simultaneously.

The controller 20 may instruct the robot 14 to connect all the electrical connectors 21a of the wiring harness 12 one at a time to the vehicle modules 18 so that the wiring harness 12 is unwound from the spool 16 and installed into the vehicle 17. The electrical connectors 21a may be connected to the vehicle modules 18 and disconnected from the retaining features 26 in a predetermined sequence to further inhibit tangling of the wire harness 12. For example, the controller 20 instructs the robot 14 to connect adjacent electrical connectors 21a to the vehicle 17 to inhibit the wiring harness 12 from getting tangled during installation. The system 10 of the present disclosure provides the benefit of inhibiting the spool 16 and the wire harness 12 from getting tangled during shipping and allows the spool 16 to be reusable after the wire harness 12 has been installed into the vehicle 17. The system 10 also allows the installation of the wiring harness 12 into the vehicle 17 to be automated.

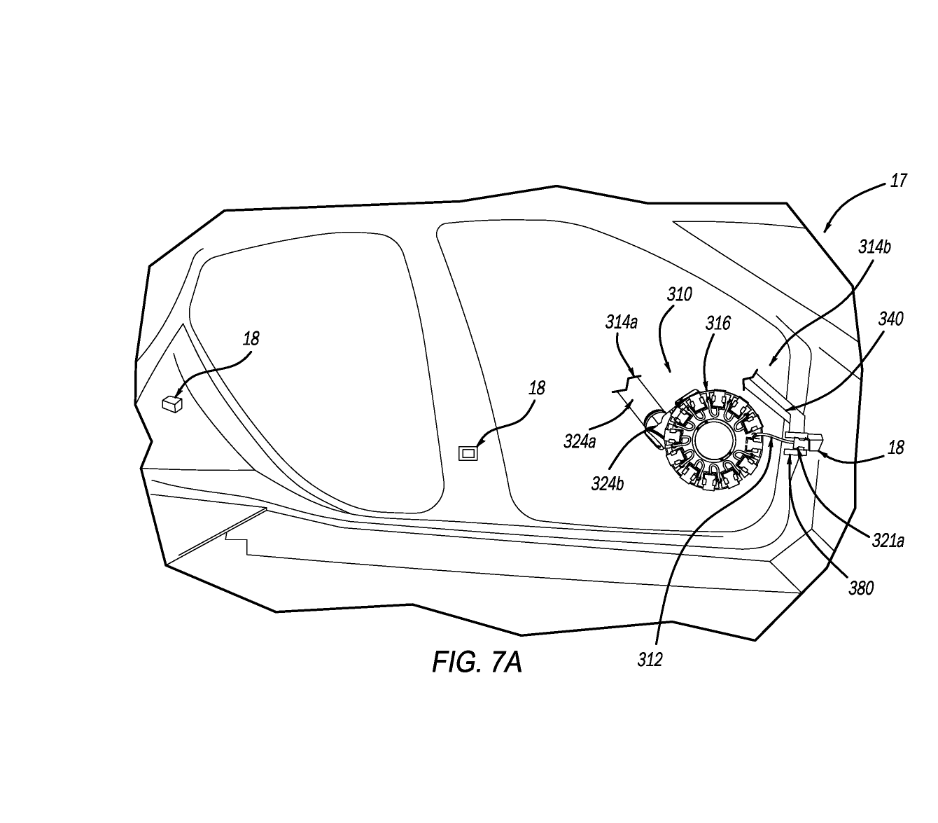

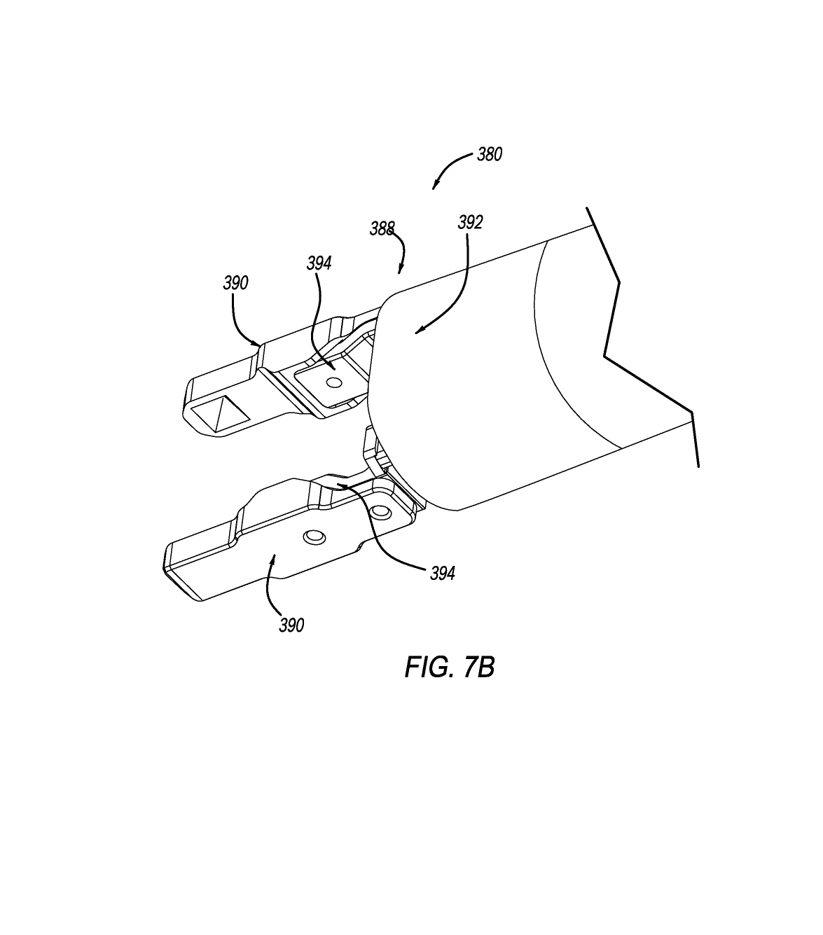

With reference to FIGS. 7A, 7B, 8 and 9, another system 310 for handling one or more wire harnesses 312 is illustrated. The structure and function of the system 310 may be similar or identical to the system 10 described above, except for the differences noted below.

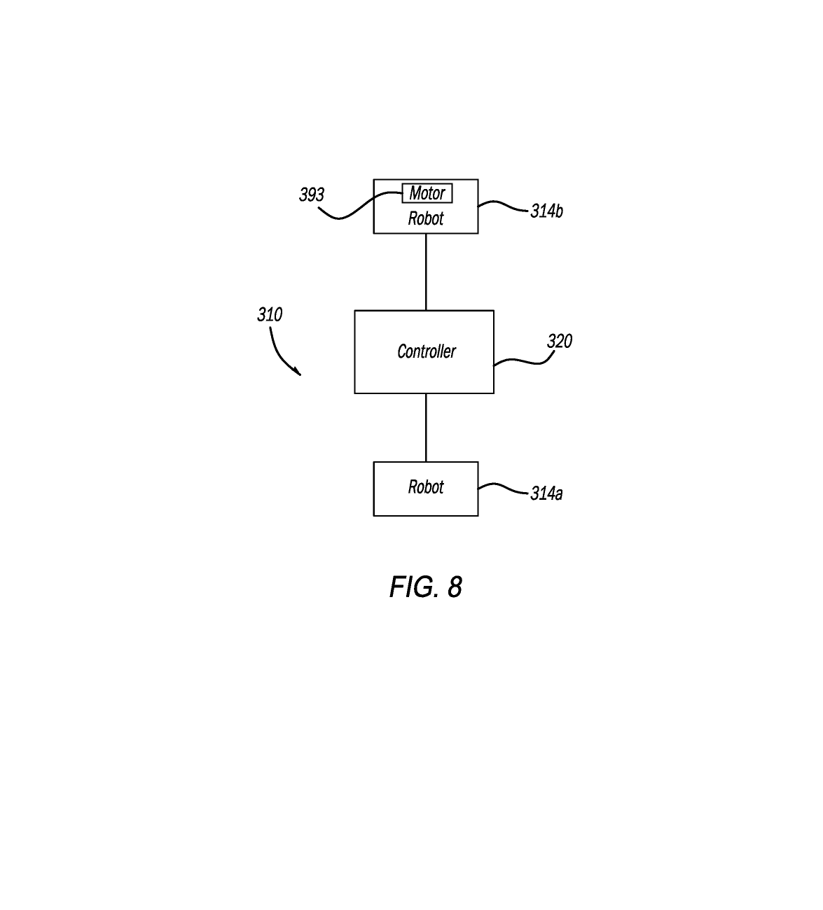

The system 310 includes robots 314a, 314b, a spool 316, and a controller 320 (FIG. 8). The robot 314a is configured to move the spool 316 and the vehicle component 312 from the work surface (not shown), for example, to the vehicle 17 and along a length of the vehicle 17. The robot 314a includes a robot arm 324a and a robotic gripper structure or apparatus 324b. The structure and function of the robot 314a may be similar or identical to the robot 14 described above, and therefore, will not be described again in detail.

The robot 314b is configured to connect electrical connectors 321a of the wiring harness 312 to the vehicle modules 18 of the vehicle 17 and disconnect or detach the electrical connectors 321a of the wiring harness 312 from the spool 316. The robot 314b includes a robot arm 340 and a robotic gripper structure or apparatus 380. The robot arm 340 includes a plurality of segments connected to each other at joints, thereby allowing the robot 314b to have multiple degrees of freedom. The robot arm 340 may be secured to a work surface at a first end. In some variations, the robot arm 340 includes an optional adapter (not shown) that is adapted to be secured to the work surface. In some forms, the robot 314b is separate from the work surface and is partially or fully autonomous and is configured to autonomously move to the part support (not shown) and/or work surface as instructed by the controller 320. To autonomously move itself, the controller 320 is configured to control various movement systems of the robot 314b based on location data obtained from one or more sensors. In an example application, the movement systems may include propulsion systems, steering systems for controlling wheels, and/or other systems, and the sensors for providing location data may include a GNSS sensor, an imaging sensor, a local position sensor, among others.

The robotic gripper structure 380 is secured to the robot arm 340 and is configured to grasp and move the electrical connectors 321a of the wire harness 312 from the spool 316. The robotic gripper structure 380 is also configured to connect the electrical connectors 321a to the vehicle modules 18 as will be described in more detail below.

With reference to FIG. 7B, the robotic gripper structure 380 includes an actuator assembly 388 and a pair of opposed grippers 390. The actuator assembly is secured to a second end of the robot arm 340. The actuator assembly 388 includes a body 392, a motor 393 (FIG. 8), and a pair of movable members or arms 394. The body 392 is secured to the second end of the robot arm 340. The motor 393 is associated with the body 392 (e.g., disposed within the body 392) and is in electrical communication with the controller 320. The controller 320 may be in communication with the motor 393 via, for example, an internet, Wi-Fi, Bluetooth®, Zigbee®, power-line carrier communication (PLCC), or cellular connection or any other wired or wireless communication protocol. The motor 393 is operable between an OFF mode and an ON mode. In one form, the motor 393 may be an electric motor such as a brushless drive motor. Each arm 394 is operatively connected to the motor 393 via a respective rail or connecting member (not shown) and is allowed to move in a transverse direction (i.e., transverse to a longitudinal direction of the arm 394). For example, when the motor 393 is in the OFF mode, the arms 394 are inhibited from moving in the transverse direction. When the motor 393 is in the ON mode, the arms 394 are allowed to move in the transverse direction between an open state and a closed state.

Each gripper 390 is secured to a respective arm 394 and is movable in a transverse direction between a first or closed position and a second or open position. Stated differently, each gripper 390 is secured to the respective arm 394 such that when the respective arm 394 is moved to the closed state, the gripper 390 is moved to the closed position, and when the respective arm 394 is in the open state, the gripper 390 is in the open position. When the grippers 390 are in the closed position, the grippers 390 may grasp and move the electrical connectors 321a. When the grippers 390 are in the open position, the grippers 390 are disengaged from the electrical connectors 321a. One example of such pair of grippers is disclosed in U.S. Patent App. No. XX/000,000, and titled “SYSTEM FOR HANDLING ELECTRICAL COMPONENTS,” which is commonly owned with the present application and the contents of which are incorporated herein by reference in its entirety.

The spool 316 is configured to support the wiring harness 312. The structure and function of the spool 316 may be similar or identical to the spool 16 described above, and therefore, will not be described again in detail. With reference to FIG. 8, the controller 320 is in communication with the robots 314a, 314b and may monitor and control operations of the robots 314a, 314b based on data received. In one example, the controller 320 is in communication with the robots 314a, 314b using a wired or wireless communication protocol (e.g., a Bluetooth®-type protocol, a cellular protocol, a wireless fidelity (Wi-Fi)-type protocol, a near-field communication (NFC) protocol, an ultra-wideband (UWB) protocol, among others).

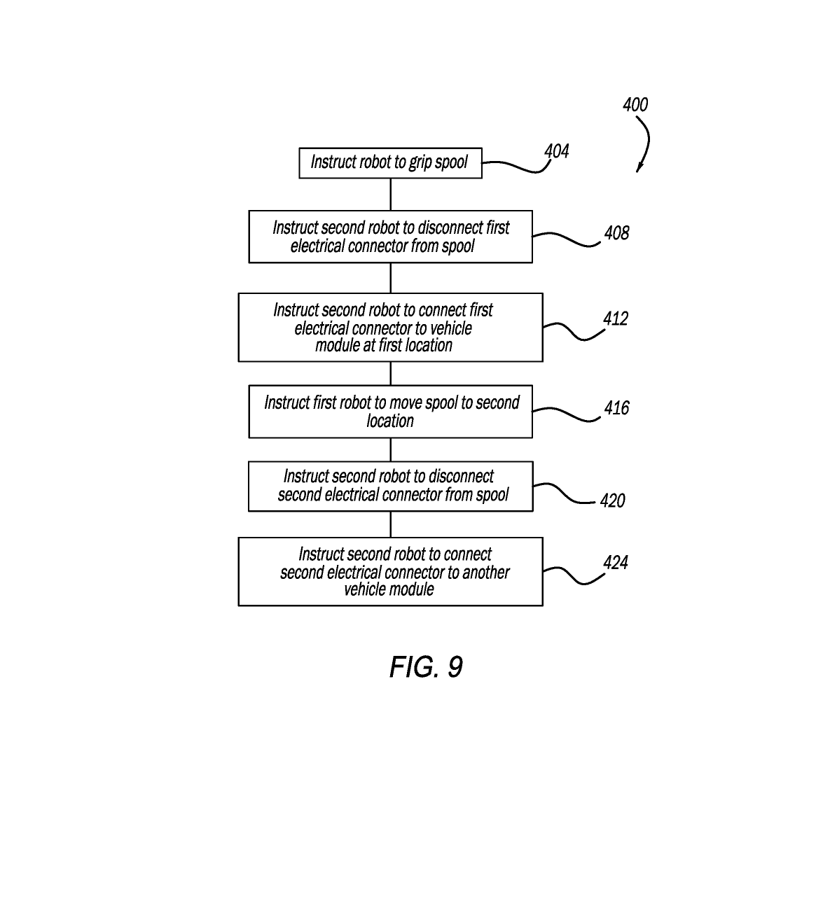

Referring to FIG. 9, an example control algorithm 400 for installing the wiring harness 312 into the vehicle 17 is illustrated. The processing may begin once the wiring harness 312 is moved from the part support (not shown) to the work surface or the area where the robots 314a, 314b are located. At 404, the control algorithm, using the controller 320, instructs the robot 314a to grip the spool 316 having the wiring harness 312 wound thereon and move it toward the spool 316. At 408, the control algorithm, using the controller 320, instructs the robot 314b to disconnect or detach the first electrical connector 321a from the spool 316 (i.e., detach the first electrical connector 321a from the respective retaining feature of the spool 316).

At 412, the control algorithm, using the controller 320, instructs the robot 314b to connect the first electrical connector 321a to a respective vehicle module 18. In the example illustrated, the respective module 18 is located at a front of the vehicle 17. In another form, the respective module 18 may be located at a rear of the vehicle 17. In yet another form, the respective module 18 may be located at a middle portion of the vehicle 18 or any other location of the vehicle 17 including vehicle modules.

At 416, the control algorithm, using the controller 320, instructs the robot 314a to move the spool 316 to a second location of the vehicle 17 that is spaced apart from the first location of the vehicle 17.In the example illustrated, the second location of the vehicle 17 may be a middle portion of the vehicle 17. In some forms, the second location of the vehicle 17 may be a rear of the vehicle 17 or another location of the vehicle 17 that is spaced apart from the front of the vehicle 17. It should be understood that the wiring harness 312 may be at least partially unwound on the spool 316 in response to the robot 314a moving from the first location toward the second location.

At 420, the control algorithm, using the controller 320, instructs the robot 314b to disconnect or detach the second electrical connector 321a from the spool 316 (i.e., detach the second electrical connector 321a from the respective retaining feature of the spool 316). At 424, the control algorithm, using the controller 320, instructs the robot 314b to connect the second electrical connector 321a to another vehicle module 18 of the vehicle 17. The controller 320 may instruct the robot 314a to move along the vehicle 17 and the robot 314b to connect all the electrical connectors 321a of the wiring harness 312 one at a time to the vehicle modules 18, so that the wiring harness 312 is unwound from the spool 316 and installed into the vehicle 17.

Unless otherwise expressly indicated herein, all numerical values indicating mechanical/thermal properties, compositional percentages, dimensions and/or tolerances, or other characteristics are to be understood as modified by the word “about” or "approximately" in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A system for installing a wiring harness into a vehicle, the system comprising:
a spool configured to support the wiring harness and including a first retaining feature, the first retaining feature configured to couple a first connector of the wiring harness to the spool;
at least one robot coupled to the spool and configured to move the spool; and
a controller in communication with the at least one robot, the controller configured to:
instruct the at least one robot to connect the first connector to a first module of the vehicle; and
instruct the at least one robot to disconnect the first connector from the first retaining feature.

2. The system of claim 1, wherein the at least one robot connects the first connector to the first module and disconnects the first connector from the first retaining feature simultaneously.

3. The system of claim 1, wherein the spool includes a body, a first flange and a second flange opposite the first flange, and wherein the first retaining feature is coupled to the first flange.

4. The system of claim 3, wherein the robot is coupled to the body of the spool.

5. The system of claim 3, wherein the spool includes a second retaining feature spaced apart from the first retaining feature, and wherein the second retaining feature is configured to couple a second connector of the wiring harness to the spool.

6. The system of claim 5, wherein each of the first and second retaining features includes a clip or hook-and-loop fastener.

7. The system of claim 5, wherein the controller is configured to:
instruct the at least one robot to connect the second connector to a second module of the vehicle after the first connector is connected to the first connector; and
instruct the at least one robot to disconnect the second connector from the second retaining feature,
wherein the second module is spaced apart from the first module.

8. The system of claim 7, wherein the second retaining feature is coupled to the first flange.

9. The system of claim 7, wherein the second retaining feature is coupled to the second flange.

10. The system of claim 7, wherein the at least one robot connects the second connector to the second module and disconnects the second connector from the second retaining feature simultaneously.

11. A system for installing a wiring harness into a vehicle, the system comprising:
a spool configured to support the wiring harness and including a plurality of retaining features, a first retaining feature of the plurality of retaining features configured to couple a first connector of the wiring harness to the spool and a second retaining feature of the plurality of retaining features configured to couple a second connector of the wiring harness to the spool;
at least one robot coupled to the spool and configured to move the spool; and
a controller in communication with the at least one robot, the controller configured to:
instruct the at least one robot to connect the first connector to a first module located at a first location of the vehicle;
instruct the at least one robot to disconnect the first connector from the first retaining feature;
instruct the at least one robot to move the spool to a second location of the vehicle to connect the second connector to a second module of the vehicle after the first connector is connected to the first module; and
instruct the at least one robot to disconnect the second connector from the second retaining feature,
wherein the wiring harness is at least partially unwound on the spool in response to the at least one robot moving the spool from the first location toward the second location.

12. The system of claim 11, wherein the at least one robot connects the first connector to the first module and disconnects the first connector from the first retaining feature simultaneously, and wherein the at least one robot connects the second connector to the second module and disconnects the second connector from the second retaining feature simultaneously.

13. The system of claim 11, wherein each of the plurality of retaining features includes a clip or hook-and-loop fastener.

14. The system of claim 11, wherein the spool includes a first flange and a second flange opposite the first flange, and wherein the first and second retaining features are coupled to a periphery of the first flange.

15. The system of claim 14, wherein the plurality of retaining features includes a third retaining feature configured to couple a third connector of the wiring harness to the spool, and wherein the controller is configured to:
instruct the at least one robot to move from the second location to a third location of the vehicle to connect the third connector to a third module of the vehicle after the second connector is connected to the second module; and
instruct the at least one robot to disconnect the third connector from the third retaining feature,
wherein the wiring harness is further unwound on the spool in response to the at least one robot moving the spool from the second location toward the third location.

16. The system of claim 15, wherein the third retaining feature is coupled to the periphery of the first flange.

17. The system of claim 15, wherein the third retaining feature is coupled to a periphery of the second flange.

18. The system of claim 11, wherein the at least one robot includes:
a first robot configured to move the spool from the first location to the second location; and
a second robot configured to disconnect the first connector from the first retaining feature and connect the first connector to the first module of the vehicle and disconnect the second connector from the second retaining feature and connect the second connector to the second module of the vehicle.

19. A system for installing a wiring harness into a vehicle, the system comprising:
a spool including a first flange, a second flange opposite the first flange, and a plurality of retaining features coupled to at least one of the first flange and second flange;
the wiring harness wound around the spool and including a plurality of connectors; each retaining feature of the plurality of retaining features configured to couple a respective connector of the plurality of connectors to the spool;
at least one robot coupled to the spool and configured to move the spool; and
a controller in communication with the at least one robot, the controller configured to:
instruct the at least one robot to connect a first connector of the plurality of connectors to a first module located at a first location of the vehicle;
instruct the at least one robot to disconnect the first connector from a first retaining feature of the plurality of mounting features;
instruct the at least one robot to move the spool to a second location of the vehicle to connect a second connector of the plurality of connectors to a second module of the vehicle after the first connector is connected to the first module; and
instruct the at least one robot to disconnect the second connector from the second retaining feature of the plurality of mounting features,
wherein the wiring harness is at least partially unwound on the spool in response to the at least one robot moving the spool from the first location toward the second location.

20. The system of claim 19, wherein the at least one robot includes:
a first robot configured to move the spool from the first location to the second location; and
a second robot configured to disconnect the first connector from the first retaining feature and connect the first connector to the first module of the vehicle and disconnect the second connector from the second retaining feature and connect the second connector to the second module of the vehicle.
